(19) United States
(12) Patent Application Publication
(10) Pub. No.: US 2006/0142452 A1
(43) Pub. Date: Jun. 29, 2006

(54) Polyolfins, methods of making polyolefins and related plastic additive compositions

(76) Inventors: Sonya Wolters, Boiling Springs, SC (US); Kemper David Lake JR., Spartanburg, SC (US); Bhavesh C. Gandhi, Powai-Mumbai (IN); Jiang Li, Spartanburg, SC (US); Jiannong Xu, Spartanburg, SC (US)

Correspondence Address: Legal Department;M-495, P.O. Box 1926, Spartanburg, SC, 29304, US

(21) Appl. No.: 11/211,906

(22) Filed: Aug. 25, 2005

Related U.S. Application Data
(60) Provisional application No. 60/639,092, filed on Dec. 23, 2004.

(51) Int. Cl. C08K 5/09

(52) U.S. Cl. 524/394; 524/543

(57) ABSTRACT

A thermoplastic is disclosed providing: a polyolefin, a nucleating agent, and stearate-containing compounds having fatty acid anionic portions selected from calcium, zinc, sodium, lithium, aluminum, and magnesium. In some applications, calcium stearate and zinc stearate may be combined synergistically in such a thermoplastic. The nucleating agent may be of many forms, including for example a dicarboxylate salt, such as a metal salt of bicyclic[2.2.1]heptane dicarboxylate salt, as one example.

### CROSS REFERENCE TO RELATED APPLICATIONS

This application claims priority to a related provisional application “HPN68L Reformulation for Haze Reduction, Tc Improvement and Impact Property Improvement”, U.S. Ser. No. 60/639,092 filed Dec. 23, 2004.

### BACKGROUND OF THE INVENTION

Thermoplastics such as polyolefins are used in a variety of end-use applications, including storage containers, medical devices, food packages, plastic tubes and pipes, packaging, shelving units, and the like. Such base compositions must exhibit certain physical characteristics to facilitate widespread use.

To achieve desirable physical properties, certain compounds and compositions may be added to polymers which provide nucleation sites for polymer crystal growth during molding or fabrication processes. Compositions containing such nucleating compounds typically crystallize at a higher crystallization temperature and at a faster rate than compositions without such nucleating compounds.

Such compounds and compositions that enable faster polymer nucleation rate and or higher polymer crystallization temperature are thus known as nucleating agents or nucleators. Such compounds are, as their name suggests, utilized to provide nucleation sites for crystal growth during cooling of a thermoplastic molten formulation.

The efficacy of a nucleating compound is typically measured by the peak crystallization temperature (Tc) of the polymer compositions containing such nucleating agents. A high polymer peak crystallization temperature is indicative of high nucleation efficacy, which generally translates into faster nucleation rate and thus shorter processing cycle time.

Generally, the presence of many nucleation sites associated with adding a nucleator results in a larger number of smaller crystals. As a result of the smaller crystals formed therein, clarification of the target thermoplastic may also be achieved, although excellent clarity is not always a result. For applications that require good clarity of the thermoplastic article, an additive that induces low haze measurements within the final product is added to the polymer composition. Such compounds are generally called clarifying agents or clarifiers.

A combination of high nucleation efficacy (indicated by high polymer crystallization temperature) and high article clarity (indicated by low haze) is desirable; however, to date there are very few additives that provide effective low haze and high peak crystallization temperatures within the polymer.

An effective clarifying agent known to the industry and available commercially is dibenzylidene sorbitol acetal derivative compounds (“DBS”). Such compounds are typical nucleator compounds, particularly for polypropylene end-products, and include, without limitation: compounds such as 1,3-O-2,4-bis(3,4-dimethylbenzylidene)sorbitol, available from Milliken & Company under the trade name Millad® 3988 (hereinafter referred to as 3,4-DMDBS), 1 ,3-O-2,4-bis(p-methylbenzylidene)sorbitol, also available from Milliken & Company under the trade name Millad® 3940 (hereinafter referred to as p-MDBS). Such clarifying agents impart high article clarity when used in polyolefin compositions.

A commercially available effective nucleator is a salt of bicyclic[2.2.1]heptane dicarboxylate. It is commonly known as Hyperform HPN-68 and the specific structure is shown as follows. This nucleator is available from Milliken & Company under the trade name Hyperform™ HPN-68L which is a mixture of HPN-68, as further described herein. HPN-68L has been reported to impart the highest nucleation efficacy (highest polymer peak crystallization temperature) for polypropylene. When added to polypropylene, HPN-68 also enhances plastic article physical properties such as isotropic shrinkage.

Other commercially known nucleators include sodium benzoate, sodium 2,2′-methylene-bis-(4,6-di-tert-butylphenyl)phosphate (from Asahi Denka Kogyo K.K., known as and hereinafter referred to as NA-11®), aluminum bis[2,2′-methylene-bis-(4,6-di-tert-butylphenyl)phosphate] with lithium myristate (also from Asahi Denka Kogyo K.K., which is understood to be known as and hereinafter referred to as NA-21®), talc, and the like.

Efforts have been made to employ certain additives to improve the dispersion of pigments or improve rheological properties of polypropylene. See Kaloforov Nikola, CSc. Bratislava, “Method for Improvement of Dispersal Regulation and Improvement of Rheological Properties of Polypropylene”, Czechoslovak Socialist Republic Invention Specification, published Jul. 15, 1982. The additives disclosed in this reference include mixtures of calcium stearate and zinc stearate, for the production of polypropylene (PP) fiber for filament yarn.

There is a need in the thermoplastics industry for additive packages that provide improved plastic article performance. An additive composition that can decrease haze for high article clarity and increase polymer crystallization temperature for high nucleation capability, would be particularly beneficial. This invention is directed at such compositions.

### DETAILED DESCRIPTION OF THE INVENTION

Reference now will be made to the embodiments of the invention, examples of which are set forth below. Each example is provided by way of explanation of the invention, not as a limitation of the invention. In fact, it will be apparent to those skilled in the art that various modifications and variations can be made in this invention without departing from the scope or spirit of the invention.

The invention may come in many forms and variations. Compounds as shown herein, and salts thereof, may be useful in the application of the compositions of the invention.

A nucleating agent as disclosed is combined with a first and a second fatty acid salt. The combination of these two fatty acid salts with the nucleating agent in a thermoplastic (or polyolefin) composition provides surprisingly beneficial and synergistic effects upon haze of thermoplastic articles made with the composition.

A thermoplastic composition may be provided, as follows:
(a) a polyolefin,
(b) a nucleating agent having the structure: 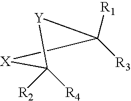
wherein X and Y are independently:
C₁₋₁₈ alkylene, C₂₋₁₈ alkenylene, C₃₋₁₈ cycloalkylene, C₄₋₁₈ cycloalkenylene, or arylene;
R1 and R2 are independently —H, C₁₋₁₈ alkyl, or —COR5;
R3 and R4 together form A-B-C, wherein A and C are independently C═O, —O—, —CR6R7-, or —CR6-; and
B is a single or double bond, or when neither A nor C is —O—, B can be —O—;
R5 is —OH, —O—C₁₋₁₈ alkyl, —O-aryl, or —NRR′;
each R6 and R7 is independently —H, halogen, C₁₋₁₈ alkyl, C₃₋₁₈ cycloalkyl, —COR5, —CRR′—COR5, or —NRR′;

Each R and R′ is independently —H, C₁₋₁₈ alkyl, C₃₋₁₈ cycloalkyl, or C₁₋₁₈ alkyl substituted by one or more —OH, halogen, —COOH, COOC₁₋₁₈ alkyl, C₁₋₁₈ alkylene-S—C₁₋₁₈ alkyl, aryl, or substituted aryl groups; or a salt thereof; and
(c) a first fatty acid salt having a first cationic counter ion, said first cationic counter ion being selected from the group consisting of: calcium, sodium, lithium, and barium; and
(d) a second fatty acid salt having a second cationic counter ion, said second cationic counter ion being selected from the group consisting of: magnesium, aluminum, and zinc.

In other applications of the invention, a stearic acid scavenger and a synthetic hydrotalcite compound such as DHT-4A (see Examples 22-26 below) may be employed instead of or in addition to the first and second fatty acid salts.

In one application of the invention, at least one of said first and second fatty acid salts comprises a derivative of stearic acid or myristic acid. The first fatty acid salt may comprise calcium stearate, or zinc stearate, or a derivative of myristic acid, or a combination of one or more of these salts.

In yet another embodiment of the invention, a thermoplastic composition is disclosed, comprising: (a) a polyolefin, (b) a nucleating agent comprising a dicarboxylate salt compound; (c) a first fatty acid salt having a first cationic counter ion selected from the group consisting of: calcium, sodium, lithium, and barium; and (d) a second fatty acid salt having a second cationic counter ion being selected from the group consisting of: magnesium, aluminum, and zinc.

The nucleating agent may be any compound as described above. However, one useful compound that may be employed as the nucleating agent is shown below:

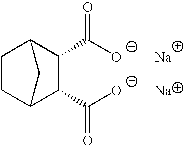

In one effective embodiment, the thermoplastic composition comprises: (a) polypropylene; (b) a nucleating agent (such as for example a dicarboxylate salt); (c) calcium stearate; and (d) zinc stearate. The use of these two stearates together has been found to be beneficial and synergistic, as further disclosed herein. In one application, the salt employed is bicyclo[2.2.1]heptane dicarboxylate salt, which has been found to benefit greatly from this combination.

### DEFINITIONS

ppm=parts per million by weight
Hyperform™ HPN-68: a specific metal salt of bicyclic[2.2.1]heptane dicarboxylate salts with the structure as shown below.
HPN-68L® contains 80 percent HPN-68.

The structure is shown below:

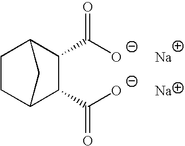

The following fatty acid salts may be employed in the practice of the invention, either alone or in combination. They may be used to scavenge acids to prevent degradation and yellowing of polymers. These compounds will be designated herein as “acid scavengers” even though they could function other than as scavengers of acids.
CaSt (([(CH₃(CH₂)₁₆CO₂]₂Ca): Calcium stearate
ZnSt ([(CH₃(CH₂)₁₆CO₂]₂Zn): Zinc stearate
NaSt (CH₃(CH₂)₁₆CO₂Na): Sodium stearate
MgSt [(CH₃(CH₂)₁₆CO₂]₂Mg: Magnesium stearate
AlSt 132: Aluminum tristearate
AlSt 22: Aluminum distearate
LiSt (CH₃(CH₂)₁₆CO₂Li): Lithium stearate
DHT-4A (Mg_{4.3}Al₂(OH)_{12.6}CO₃— mH₂O): a synthetic hydrotalcite compound.

It has been discovered that a mixture of two or more of the selected acid scavengers may provide synergistic performance enhancement for a particulate nucleator in polyolefin systems. A performance enhancement of the thermoplastic may be realized in haze reduction, improved color, increased peak crystallization temperature, or impact property improvement. It is speculated that the specific combination of acid scavengers may improve the dispersion of the particulate nucleating agent. In one embodiment of the invention, a desirable thermoplastic composition comprises: (a) polypropylene, (b) a nucleating agent, (c) calcium stearate; and (d) zinc stearate.

A thermoplastic is provided in another aspect of the invention comprising: (a) a semi-crystalline polymer, (b) a nucleating agent, (c) a first co-additive compound, said co-additive compound having a fatty acid anionic portion and a first cationic portion, said first cationic portion being selected from the group consisting of: calcium, sodium, and lithium; and (d) a second co-additive compound that is a synthetic hydrotalcite, such as DHT-4A, further discussed herein.

In the practice of the invention, a “fatty acid” in general refers to a carboxylic acid with at least eight carbons, commonly between twelve and twenty carbons. The structure could contain but not limited to saturated, unsaturated, ring, or branch structures. Also, the structure could contain heteroatoms, such as O, N, P, F, Cl, Br, and I.

### Polyolefins and Related Compounds

The term “polyolefin” or “polyolefin resin” is intended to encompass any materials comprised of at least one polyolefin compound. Examples include isotactic and syndiotactic polypropylene, polyethylene, poly(4-methyl)pentene, polybutylene, and any blends or copolymers thereof, whether high or low density in composition. The polyolefin polymers of the present invention may include aliphatic polyolefins and copolymers made from at least one aliphatic olefin and one or more ethylenically unsaturated co-monomers. Generally, the co-monomers, if present, will be provided in a minor amount, such as about 10 percent or less or even about 5 percent or less, based upon the weight of the polyolefin (e.g. random copolymer polypropylene). Copolymers containing up to 25% or more of the co-monomer (e.g., impact copolymers) are also contemplated within the scope of the invention. Other polymers or rubber (such as EPDM or EPR) may also be compounded with the polyolefin. Such co-monomers may serve to assist in clarity improvement of the polyolefin, or they may function to improve other properties of the polymer. Other examples of co-monomers include acrylic acid and vinyl acetates.

The compositions of the present invention may be obtained by adding the nucleating agent, such as the saturated bicyclic dicarboxylic salt (or combination of salts or composition comprising such salts) to the thermoplastic polymer or copolymer and merely mixing the resultant composition by any suitable means. Alternatively, a concentrate containing as much as about 20 percent by weight of the nucleating agent with fatty acid salts in a polyolefin masterbatch (comprising the required acid scavengers) may be prepared and be subsequently mixed with the target resin. Furthermore, the inventive compositions may be present in any type of standard thermoplastic additive form, including, without limitation, powder, prill, agglomerate, liquid suspension, and the like, particularly comprising dispersion aids such as polyolefin (e.g., polyethylene) waxes, stearate esters of glycerin, montan waxes, or mineral oil. Basically, any form may be exhibited by such a combination or composition including such combination made from blending, agglomeration, compaction, or extrusion.

The composition may be processed and fabricated by any number of different techniques, including, without limitation, injection molding, injection blow molding, injection stretch blow molding, injection rotational molding, extrusion, extrusion blow molding, sheet extrusion, film extrusion, cast film extrusion, foam extrusion, thermoforming (such as into films, blown-films, biaxially oriented films), thin wall injection molding, and the like into a fabricated article.

### EXAMPLE 1

### Homopolymer 113 Mil Plaques

Polypropylene homopolymer having a twelve melt flow rate (grams/10 min) with an additive package consisting of antioxidants, acid scavenger as specified and a nucleating agent such as HPN-68L were melt-compounded and subsequently molded into plastic plaques (2″×0.113″). The formulations of the Example 1 and Comparative Example 1 are listed in table 1 (antioxidants are standard formulation and not listed herein or throughout this article).

TABLE 1
Formulation of Example 1 and
Comparative Example 1

| | | | Acid | | Acid | |
|---|---|---|---|---|---|---|
| | | Loading | scav- | loading | scav- | loading |
| Sample | Nucleator | (ppm) | enger 1 | (ppm) | enger 2 | (ppm) |
| Comparative | HPN- | 1200 | CaSt | 800 | None | NA |
| Example 1 | 68L | | | | | |
| Example 1 | HPN- | 1200 | CaSt | 400 | ZnSt | 400 |
| | 68L | | | | | |

The mixture was blended for one minute using a high-intensity mixer (Thyssen Henschel Company) and compounded at 230° C. using a single-screw extruder (L/D: 30:1, Deltaplast Machinery Limited). The resultant pellets were tested for melt flow rate (MFR) using a Gottfert Melt Indexer (ASTM D1238) and peak crystallization temperature (Tc) using a Perkin-Elmer Series 7 Differential Scanning Calorimeter (DSC) (modified ASTM D3417-99).

The compounded pellets were then injection-molded into 113 mil plaques using a 40-ton injection molder (Arburg, Inc, Newinton, Conn.). The mold barrel temperature was set at 230° C., the mold temperature was set at 16° C. and the injection speed was set at 2.4 cc/sec. The plaques were then tested for haze after aging for 24 hours using a BYK Gardner Haze-Gard Plus (ASTM D1003), and Gardner impact properties using a BYK Gardner impact tester (ASTM D5420). The results are shown in Table 2.

TABLE 2
Performance of Example 1
and Comparative Example 1

| | | | Gardner |
|---|---|---|---|
| | Tc | | Impact |
| Sample | (° C.) | Haze % | (J) |
| Comparative | 124.4 | 88.5 | 1.4 |
| Example 1 | | | |
| Example 1 | 126.7 | 73.6 | 3.3 |

The results show that comparing with 800 ppm CaSt, a mixture of acid scavengers CaSt and ZnSt improves the performance of nucleated polypropylene by increasing peak crystallization temperature, decreasing haze and improving impact properties. Since haze is an indication of transparency of plastic plaques and since peak crystallization temperature normally corresponds to production cycle time, the results here show that the mixture of acid scavengers makes more transparent nucleated polypropylene plastic products with potential for shorter cycle times.

### EXAMPLE 2

### Synergy Using Both CaSt and ZnSt in PP

The polypropylene homopolymer having twelve melt flow rate (grams/10 min) with specified additive package was mixed and compounded as example 1. The compounded pellets were injection-molded at 2.4 cc/sec injection speed into 50 mil plaques. The mold temperature was set at 24.7° C. Peak crystallization temperature and 24 hr haze were measured on the injection-molded plaques. Here 1200 ppm of HPN-68L was used. Table 3 lists the formulation and performance of each formulation.

TABLE 3
Comparative Examples and Example 2

| | Acid | | | | | |
|---|---|---|---|---|---|---|
| | scav- | loading | Acid | loading | Tc | |
| Sample | enger 1 | (ppm) | scavenger 2 | (ppm) | (° C.) | Haze % |
| Comparative | CaSt | 400 | | | 124.7 | 29.8 |
| Example 2 | | | | | | |
| Comparative | CaSt | 800 | | | 124.4 | 33.8 |
| Example 3 | | | | | | |
| Comparative | | | ZnSt | 800 | 122.6 | 32.7 |
| Example 4 | | | | | | |
| Example 2 | CaSt | 400 | ZnSt | 400 | 126.3 | 25.8 |

There is clearly a synergy between ZnSt and CaSt in improving the performance of nucleated polypropylene plaques with regard to increasing peak crystallization temperature and decreasing haze. Since HPN-68L is a particulate nucleator and is not soluble in polypropylene, our best thinking on why the mixture helps HPN-68L performance is that this CaSt and ZnSt mixture helps disperse HPN-68L better in polypropylene than does CaSt alone.

### EXAMPLES 3-9

### Optimum Loading Ratio of CaSt: ZnSt

The polypropylene homopolymer with specified additive package was mixed, compounded, and injection-molded as example 2. Haze and peak crystallization temperature were measured on the injection-molded plaques. 1000 ppm HPN-68L was used as the nucleator. Table 4 lists the formulation and performance of the examples and comparative examples.

TABLE 4
Comparative Example 5-7 and Example 3-9

| | Acid | | Acid | | | |
|---|---|---|---|---|---|---|
| | scav- | loading | scav- | loding | | |
| Sample | enger 1 | (ppm) | enger 2 | (ppm) | Tc (° C.) | Haze % |
| Comparative | CaSt | 400 | | | 124.7 | 30.0 |
| Example 5 | | | | | | |
| Comparative | CaSt | 800 | | | 124.0 | 36.0 |
| Example 6 | | | | | | |
| Comparative | | | ZnSt | 400 | 123.4 | 34.1 |
| Example 7 | | | | | | |
| Example 3 | CaSt | 300 | ZnSt | 200 | 125.5 | 25.2 |
| Example 4 | CaSt | 300 | ZnSt | 300 | 126.0 | 24.1 |
| Example 5 | CaSt | 300 | ZnSt | 400 | 126.6 | 23.0 |
| Example 6 | CaSt | 300 | ZnSt | 500 | 126.3 | 24.8 |
| Example 7 | CaSt | 400 | ZnSt | 200 | 125.5 | 26.0 |
| Example 8 | CaSt | 400 | ZnSt | 300 | 126.0 | 24.6 |
| Example 9 | CaSt | 400 | ZnSt | 400 | 126.2 | 26.4 |

The results show that 300 ppm CaSt and 400 ppm ZnSt might be the optimum loading for the CaSt and ZnSt mixture formulation for this nucleated polypropylene system with the lowest plaque haze and highest peak crystallization temperature. For different systems (for example, different polymer or different nucleator), the optimum loading could be different.

### EXAMPLES 10-15

### Lower MFR Polypropylene

Plaques of Examples 10-15 and comparative examples were prepared as example 2 except that the polypropylene used is a homopolymer with a melt flow rate of 3.5 and the plaques were injection-molded at 2.4 cc/sec. 1000 ppm HPN-68L was used as the nucleator. Haze and peak crystallization temperature were measured on the injection-molded plaques. Table 5 lists the formulation and performance of the examples and comparative example 7.

TABLE 5
Comparative Examples and
Examples for Polypropylene PH350

| | Acid | | | | | |
|---|---|---|---|---|---|---|
| | scav- | loading | Acid | loading | Tc | |
| Sample | enger 1 | (ppm) | scavenger 2 | (ppm) | (° C.) | Haze % |
| Comparative | CaSt | 300 | | | — | 28.7 |
| Example 8 | | | | | | |
| Comparative | CaSt | 400 | | | 123.8 | 24.6 |
| Example 9 | | | | | | |
| Example 10 | CaSt | 200 | ZnSt | 400 | 125.1 | 22.6 |
| Example 11 | CaSt | 200 | ZnSt | 450 | 125.5 | 22.5 |
| Example 12 | CaSt | 300 | ZnSt | 300 | 125.6 | 21.6 |
| Example 13 | CaSt | 300 | ZnSt | 400 | 125.8 | 21.8 |
| Example 14 | CaSt | 350 | ZnSt | 300 | 125.2 | 21.8 |
| Example 15 | CaSt | 350 | ZnSt | 400 | 125.4 | 22.3 |

The results show that this unique formulation of mixing CaSt with ZnSt for nucleated polypropylene works for polypropylene with low melt flow rate resins also. Since this polypropylene homopolymer is suitable for thermoforming, these examples indicate that this formulation may make clear polypropylene extruded sheet or thermoformed containers with fast cycle times.

### EXAMPLE 16

### Higher MFR Polypropylene

Plaques of Example 16 and Comparative Example 10 were mixed and extruded as example 2 except that the polypropylene used is a polypropylene homopolymer with a melt flow rate of 30 (grams/10 min). The compounded pellets were then injection-molded at 230° C. with a mold temperature of 50° C. and injection speed of 15 cc/sec. 1000 ppm HPN-68L is used as the nucleator. Table 6 lists the formulations and performance of the plaques.

TABLE 6
Example and Comparative Example for high MFR
polypropylene

| | Acid | | Acid | | | |
|---|---|---|---|---|---|---|
| | scav- | loading | scav- | loading | | |
| Sample | enger 1 | (ppm) | enger 2 | (ppm) | Tc (° C.) | Haze % |
| Comparative | CaSt | 400 | | | 124.7 | 46.7 |
| Example 10 | | | | | | |
| Example 16 | CaSt | 400 | ZnSt | 400 | 126.7 | 36.6 |

The results show that this unique formulation of mixing CaSt with ZnSt for nucleated polypropylene works for polypropylene resins with higher melt flow rates. This unique mixture imparts higher Tc and lower haze for Hyperform in polypropylene with a higher processing speed.

### EXAMPLE 17

### Polypropylene Impact Copolymer

Polypropylene medium impact copolymer (ICP) having a melt flow rate of 20 grams/10 min with specified additive packages was mixed, compounded, and injection-molded as example 2. Haze and peak crystallization temperature were measured on the injection-molded plaques. 800 ppm HPN-68L was used as the nucleator. Table 7 lists the formulation and performance of the example and comparative example.

TABLE 7
Example and Comparative Example in ICP polymer

| | Acid | Loading | Acid | Loading | |
|---|---|---|---|---|---|
| Sample | Scavenger 1 | (ppm) | Scavenger 2 | (ppm) | Tc (° C.) |
| Comparative | CaSt | 800 | | | 123.4 |
| Example 11 | | | | | |
| Example 17 | CaSt | 450 | ZnSt | 450 | 125.0 |

The results show that the unique formulation of CaSt and ZnSt increases peak crystallization temperature of polypropylene impact copolymer, which subsequently indicates possible lower cycle time and faster production speed.

### EXAMPLES 18-21

### Synergy of CaSt with AlSt

The polypropylene homopolymer with specified additive package was mixed, compounded, and injection-molded as example 2. Haze and peak crystallization temperature were measured on the injection-molded plaques. 1000 ppm HPN-68 was used as the nucleator. Table 8 lists the formulation and performance of the examples and comparative examples. The results show that a mixture of AlSt and CaSt enables HPN-68 to have exceptional performance and shows that aluminum tristearate works better than aluminum distearate.

TABLE 8
Comparative Example 11 and Example 18-21

| | Acid | | | | | |
|---|---|---|---|---|---|---|
| | scav- | loading | Acid | loading | Tc | |
| Sample | enger 1 | (ppm) | scavenger 2 | (ppm) | (° C.) | Haze % |
| Comparative | CaSt | 400 | | | 124.2 | 34.8 |
| Example | | | | | | |
| 12 | | | | | | |
| Example 18 | CaSt | 400 | AlSt 132 | 200 | 125.0 | 28.3 |
| Example 19 | CaSt | 400 | AlSt 132 | 1000 | 125.7 | 25.9 |
| Example 20 | CaSt | 400 | AlSt 22 | 200 | 124.9 | 28.6 |
| Example 21 | CaSt | 400 | AlSt 22 | 1000 | 125.4 | 27.5 |

### EXAMPLES 22-26

### Synergy of LiSt, NaSt, AlSt, ZnSt, or MgSt with DHT-4A

The polypropylene homopolymer with specified additive package was mixed, compounded, and injection-molded as example 2. Haze and peak crystallization temperature were measured on the injection-molded plaques. 1000 ppm HPN-68L was used as the nucleator. Table 9 lists the formulation and performance of the examples and comparative examples. The results show that DHT-4A by itself is not an exceptional acid scavenger with high plaque haze and low polymer crystallization temperature, but it has synergy with many stearate acid scavengers such as LiSt, NaSt, AlSt, ZnSt and MgSt and decreases the haze of polypropylene homopolymer with HPN-68 as the nucleator.

TABLE 9
Comparative Example 13-19 and Example 22-26

| | | | | | | | Haze |
|---|---|---|---|---|---|---|---|
| | | | | | | | deduction |
| | | | | | | | after |
| | Acid | Loading | Acid | Loading | | Tc | mixing |
| Sample | Scavenger 1 | (ppm) | Scavenger 2 | (ppm) | Haze % | (° C.) | DHT-4A |
| Comparative | | | DHT-4A | 400 | 40.4 | 123.0 | |
| Example 13 | | | | | | | |
| Comparative | | | DHT-4A | 1200 | 38.0 | 123.3 | |
| Example 14 | | | | | | | |
| Comparative | LiSt | 400 | | | 26.0 | 126.6 | |
| Example 15 | | | | | | | |
| Comparative | NaSt | 400 | | | 31.2 | 124.6 | |
| Example 16 | | | | | | | |
| Comparative | AlSt 132 | 400 | | | 34.4 | 124.0 | |
| Example 17 | | | | | | | |
| Comparative | ZnSt | 400 | | | 37.3 | 123.1 | |
| Example 18 | | | | | | | |
| Comparative | MgSt | 400 | | | 40.6 | 120.2 | |
| Example 19 | | | | | | | |
| Example 22 | LiSt | 400 | DHT-4A | 1200 | 23.2 | 127.0 | 2.8 |
| Example 23 | NaSt | 400 | DHT-4A | 1200 | 28.6 | 124.6 | 2.6 |
| Example 24 | AlSt 132 | 400 | DHT-4A | 1200 | 30.6 | 124.6 | 3.8 |
| Example 25 | ZnSt | 400 | DHT-4A | 1200 | 32.1 | 123.8 | 5.2 |
| Example 26 | MgSt | 400 | DHT-4A | 1200 | 34.9 | 127.5 | 5.7 |

### EXAMPLES 27-30

### Synergy of CaSt with MgSt, LiSt with AlSt. NaSt with ZnSt or AlSt

The polypropylene hompolymer with specified additive package was mixed, compounded, and injection-molded as example 2. Haze and peak crystallization temperature were measured on the injection-molded plaques. 1000 ppm HPN-68L was used as the nucleator. Table 10 lists the formulation and performance of the examples and comparative examples. The results show that there are synergies between CaSt and MgSt, or NaSt with ZnSt, or NaSt with AlSt 132, or LiSt with AlSt 132. The mixtures of acid scavengers enable exceptional performance of HPN-68L in HPP.

TABLE 10
Comparative Example 20-25 and Example 27-30

| | Acid | | | | | |
|---|---|---|---|---|---|---|
| | Scav- | Loading | Acid | Loading | | Tc |
| Sample | enger 1 | (ppm) | Scavenger 2 | (ppm) | Haze % | (° C.) |
| Comparative | CaSt | 400 | | | 33.4 | 124.6 |
| Example 20 | | | | | | |
| Comparative | | | MgSt | 400 | 40.6 | 120.2 |
| Example 21 | | | | | | |
| Comparative | NaSt | 400 | | | 31.2 | 124.6 |
| Example 22 | | | | | | |
| Comparative | LiSt | 400 | | | 28.5 | 126.4 |
| Example 23 | | | | | | |
| Comparative | | | AlSt 132 | 400 | 34.4 | 124.0 |
| Example 24 | | | | | | |
| Comparative | | | ZnSt | 400 | 37.3 | 123.1 |
| Example 25 | | | | | | |
| Example 27 | CaSt | 400 | MgSt | 400 | 30.5 | 125.6 |
| Example 28 | NaSt | 400 | AlSt 132 | 400 | 25.9 | 125.8 |
| Example 29 | NaSt | 400 | ZnSt | 400 | 30.4 | 125.0 |
| Example 30 | LiSt | 400 | AlSt 132 | 500 | 26.4 | 127.0 |

### COMPARATIVE EXAMPLES 26-33

### Other Mixture of Acid Scavengers

The polypropylene homopolymer with specified additive packages was mixed, compounded and injection-molded as example 2. 1000 ppm HPN-68L was used as the nucleator. Table 11 lists the specific combinations of mixing two strong acid scavengers and their performance. Table 12 lists the specific combinations of mixing two weak acid scavengers and their performance. The results show that there is no exceptional performance enhancement when adding two strong acid scavengers or two weak acid scavengers together.

TABLE 11
Comparative Example 26-33

| | Acid | | Acid | | | |
|---|---|---|---|---|---|---|
| | Scav- | Loading | Scav- | Loading | | |
| Sample | enger 1 | (ppm) | enger 2 | (ppm) | Haze % | Tc (° C.) |
| Comparative | CaSt | 400 | | | 30.5 | 124.9 |
| Example 26 | | | | | | |
| Comparative | | | NaSt | 400 | 32.3 | 124.1 |
| Example 27 | | | | | | |
| Comparative | | | NaSt | 800 | 29.7 | 124.5 |
| Example 28 | | | | | | |
| Comparative | LiSt | 400 | | | 26.0 | 126.6 |
| Example 29 | | | | | | |
| Comparative | LiSt | 800 | | | 28.3 | 126.7 |
| Example 30 | | | | | | |
| Comparative | CaSt | 400 | NaSt | 400 | 32.4 | 124.5 |
| Example 31 | | | | | | |
| Comparative | LiSt | 400 | NaSt | 400 | 29.5 | 126.1 |
| Example 32 | | | | | | |
| Comparative | LiSt | 400 | CaSt | 400 | 29.3 | 125.9 |
| Example 33 | | | | | | |

TABLE 12
Comparative Example 34-39

| | Acid | | | | | |
|---|---|---|---|---|---|---|
| | Scavenger | Loading | Acid | Loading | Haze | Tc |
| Sample | 1 | (ppm) | Scavenger 2 | (ppm) | % | (° C.) |
| Comparative | MgSt | 400 | | | 40.6 | 120.2 |
| Example 34 | | | | | | |
| Comparative | AlSt 132 | 400 | | | 34.4 | 124.0 |
| Example 35 | | | | | | |
| Comparative | ZnSt | 400 | | | 37.3 | 123.1 |
| Example 36 | | | | | | |
| Comparative | AlSt 132 | 400 | MgSt | 400 | 38.9 | 119.6 |
| Example 37 | | | | | | |
| Comparative | AlSt 132 | 400 | ZnSt | 400 | 34.2 | 122.8 |
| Example 38 | | | | | | |
| Comparative | ZnSt | 400 | MgSt | 400 | 42.8 | 119.1 |
| Example 39 | | | | | | |

### COMPARATIVE EXAMPLES 40-44

### Other Nucleators Including Sodium Benzoate

The polypropylene homopolymer with specified additive packages was mixed, compounded and injection-molded as example 2. 1000 ppm Sodium benzoate was used as the nucleator. Table 13 lists the formulation and performance of the injection-molded plaques. The results show that this particular mixture of CaSt and ZnSt does not give exceptional performance for sodium benzoate. Even though sodium benzoate is also a particulate nucleator as HPN-68L which does not dissolve in polypropylene, the unique performance enabled by CaSt and ZnSt does not work for this nucleator. It only works for HPN-68 or nucleators with similar structure.

TABLE 13
Sodium Benzoate formulations

| Comparative | | Acid | Loading | Acid | Loading | | |
|---|---|---|---|---|---|---|---|
| Example | Nucleator | Scavenger 1 | (ppm) | Scavenger 2 | (ppm) | Haze % | Tc (° C.) |
| 40 | Sodium | CaSt | 400 | | | 52.0 | 113.5 |
| | Benzoate | | | | | | |
| 41 | Sodium | CaSt | 800 | | | 51.5 | 113.1 |
| | Benzoate | | | | | | |
| 42 | Sodium | | | ZnSt | 400 | 44.3 | 110.9 |
| | Benzoate | | | | | | |
| 43 | Sodium | | | ZnSt | 800 | 51.6 | 110.3 |
| | Benzoate | | | | | | |
| 44 | Sodium | CaSt | 400 | ZnSt | 400 | 50.9 | 110.7 |
| | Benzoate | | | | | | |

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

1. A thermoplastic composition comprising:
(a) a polyolefin,
(b) a nucleating agent having the structure: 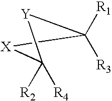
wherein X and Y are independently:
C₁₋₁₈ alkylene, C₂₋₁₈ alkenylene, C₃₋₁₈ cycloalkylene, C₄₋₁₈ cycloalkenylene, or arylene;
R1 and R2 are independently —H, C₁₋₁₈ alkyl, or —COR5;
R3 and R4 together form A-B-C, wherein A and C are independently C═O, —O—, —CR6R7-, or —CR6-; and
B is a single or double bond, or when neither A nor C is —O—, B can be —O—;
R5 is —OH, —O—C₁₋₁₈ alkyl, —O-aryl, or —NRR′;
each R6 and R7 is independently —H, halogen, C₁₋₁₈ alkyl, C₃₋₁₈ cycloalkyl, —COR5, —CRR′—COR5, or —NRR′;
Each R and R′ is independently —H, C₁₋₁₈ alkyl, C₃₋₁₈ cycloalkyl, or C₁₋₁₈ alkyl substituted by one or more —OH, halogen, —COOH, COOC₁₋₁₈ alkyl, C₁₋₁₈ alkylene-S-C₁₋₁₈ alkyl, aryl, or substituted aryl groups, or a salt thereof;
(c) a first fatty acid salt having a first cationic counter ion, said first cationic counter ion being selected from the group consisting of: calcium, sodium, lithium, and barium; and
(d) a second fatty acid salt having a second cationic counter ion, said second cationic counter ion being selected from the group consisting of: magnesium, aluminum, and zinc.

2. The composition of claim 1 wherein said nucleating agent comprises a metal salt of a dicarboxylate.

3. The composition of claim 1 wherein said polyolefin comprises polypropylene.

4. The composition of claim 1 where at least one of said first and second fatty acid salts comprises either: (a) a derivative of stearic acid or (b) a derivative of myristic acid.

5. The composition of claim 1 wherein said first fatty acid salt comprises calcium stearate.

6. The composition of claim 1 wherein said second fatty acid salt comprises zinc stearate.

7. The composition of claim 5 wherein said second fatty acid salt comprises zinc stearate.

8. A thermoplastic composition comprising:
(a) a polyolefin,
(b) a nucleating agent, said nucleating agent comprising a dicarboxylate salt compound;
(c) a first fatty acid salt having a first cationic counter ion, said first cationic counter ion being selected from the group consisting of: calcium, sodium, lithium, and barium;
(d) a second fatty acid salt having a second cationic counter ion, said second cationic counter ion being selected from the group consisting of: magnesium, aluminum, and zinc.

9. The composition of claim 8 where at least one of said first and second fatty acid salts comprises a stearate.

10. The composition of claim 8 wherein said first fatty acid salt comprises calcium stearate.

11. The composition of claim 8 wherein said second fatty acid salt comprises zinc stearate.

12. The composition of claim 8 wherein said first fatty acid salt comprises calcium stearate; said second fatty acid salt comprises zinc stearate; and said dicarboxylate salt compound comprises the following structure:

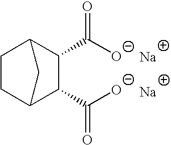

13. A thermoplastic composition comprising:
(a) polypropylene;
(b) a nucleating agent;
(c) calcium stearate; and
(d) zinc stearate.

14. The composition of claim 13 wherein said ratio of calcium stearate to zinc strearate is about 3:4.

15. The composition of claim 13 wherein said concentration of said calcium stearate in said composition is about 300 ppm.

16. The composition of claim 13 wherein said concentration of said zinc stearate in said composition is about 400 ppm.

17. The composition of claim 13 wherein said nucleating agent comprises a bicyclo[2.2.1]heptane dicarboxylate salt.

18. A polymeric article comprising the composition of claim 1.

19. A polymeric article comprising the composition of claim 8.

20. A polymeric article comprising the composition of claim 13.

21. A polymeric article comprising the composition of claim 17.

22. A method of forming a clarified polyolefin, said method comprising the steps of:
(a) providing a polyolefin,
(b) providing a nucleating agent, said nucleating agent comprising a derivative of a dicarboxylate salt compound;
(c) providing a first fatty acid salt having a first cationic counter ion, said first cationic counter ion being selected from the group consisting of: calcium, sodium, lithium, and barium;
(d) providing a second fatty acid salt having a second cationic counter ion, said second cationic counter ion being selected from the group consisting of: magnesium, aluminum, and zinc;
(e) melt compounding (a), (b), (c), and (d) to form a clarified polyolefin.
